(19) United States
(12) Patent Application Publication
(10) Pub. No.: US 2003/0058230 A1
(43) Pub. Date: Mar. 27, 2003

(54) Flat-panel type display apparatus

(75) Inventor: Shigeo Ide, Yamanashi-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Pioneer Corporation

(21) Appl. No.: 10/237,774

(22) Filed: Sep. 10, 2002

(30) Foreign Application Priority Data
Sep. 27, 2001 (JP) 2001-297012

(51) Int. Cl. G09G 5/00

(52) U.S. Cl. 345/204

(57) ABSTRACT

An improved flat-panel type display apparatus is provided which has an improved driver IC mounting structure offering a satisfactorily dissipating effect. A flexible wiring tape carrying a driver IC for driving a display body is provided on a back surface of a metal chassis supporting a back surface of the display body. An earth wiring pattern and a power-source wiring pattern are formed on the flexible wiring tape. Widened portions having the effect of dissipating heat are formed in the wiring pattern and the power-source wiring pattern around the driver IC.

### BACKGROUND OF THE INVENTION

This invention relates to a flat-panel type display apparatus using a plasma display panel or the like, more particularly, to a structure for mounting a driver IC on the flat-panel type display apparatus.

The present application claims priority from Japanese Application No. 2001-297012, the disclosure of which is incorporated herein by reference for all purposes.

Recent years, plasma display panels (PDPs) have been developed, and particularly the research and development have been explosively conducted on color plasma display panels representing the coming generation of display apparatus.

For ensuring a high definition on a display screen, a lot of integrated circuit devices for driving (hereinafter referred to as “driver IC”) must be mounted at a high density. Particularly, in mounting (at a high density) the driver IC for driving the PDP or the like at a high voltage and a high electric power, the mounting structure absolutely needs an outstanding heat-dissipating effect.

Using a mounting technique such as TAB (Tape Automated Bonding) and COF (Chip on FPC) or the like, the driver IC is carried on TCP (Tape Carrier Package) and TCP is used to connect the driver IC to electrode terminals on a substrate of a flat-display panel of the PDP or the like. In such a manner of mounting the driver IC, it is required to institute measures directed toward the realization of an adequate heat-dissipating effect with a simple mounting structure.

### SUMMARY OF THE INVENTION

The present invention has been made to solve the above problems, and therefore it is an object thereof to provide a flat-panel type display apparatus having a mounting structure for a driver IC which is capable of providing an outstanding heat-dissipating effect.

To attain the above object, the present invention provides a flat-panel type display apparatus having the following features.

According to a first aspect of the invention, the flat-panel type display apparatus includes a flat display panel and a metal chassis bonded on a back surface of the flat display panel. Specifically, the display apparatus comprises, a flexible wiring tape having predetermined signal wiring, earth wiring and power-source wiring, carrying a driver IC and connected to electrode terminals formed on a substrate of the flat display panel. In particular, at least one of the earth wiring and the power-source wiring has a widened portion formed around the driver IC.

According to a second aspect of the invention, each of the wirings on the flexible wiring tap has a thickness of 30 μm or more.

According to a third aspect of the invention, a back surface of said driver IC is covered with an electrically conductive tape, and the electrically conductive tape is connected to the widened portion and also bonded to the metal chassis.

According to a fourth aspect of the invention, the flat display panel is a color plasma display panel.

The present invention having the above features provides the following advantages.

With the use of the first aspect of the invention, in the wiring on the flexible wiring tape, the widened portion is formed around the driver IC carried on the wiring tape. This design allows the widened portion to have a function of dissipating heat. Hence, the heat generated when the driver IC drives the flat display panel can be efficiently dissipated by virtue of the heat-dissipating function.

With the use of the second aspect of the invention, the wiring on the flexible wiring tape is designed to have a thickness of 30 μm or more which is considerably larger than that of about 18 μm of wiring on a typical TCP in the prior art. The increased thickness increases the heat-dissipating effect of the wirings.

With the use of the third aspect of the invention, due to the design that the back surface of the driver IC carried on the flexible wiring tape is covered with an electrically conductive tape and the electrically conductive tape is connected to the widened portions formed in the wiring on the flexible wiring tape, the heat-dissipating functions of the electrically conductive tape and the widened portions work in combination to further increase the heat-dissipating effect. In addition, bonding the electrically conductive tape to the metal chassis allows the heat to quickly escape from the metal chassis and also allows the driver IC to be fastened to the metal chassis, resulting in stable mounting of the driver IC.

With the use of the fourth aspect of the invention, the above advantages make it possible to mount (with a high density) the driver IC capable of driving at a high voltage by a high electric power. Hence, it becomes possible to produce a color plasma display panel having a high definition.

These and other objects and features of the present invention will become more apparent from the following detailed description with reference to the accompanying drawings.

### BRIEF DESCRIPTION OF THE DRAWINGS

FIG. 1 is a sectional view illustrating an essential part of the structure of a color plasma display panel according to a first embodiment of the present invention.

FIG. 2 is a plan view illustrating the wiring structure of a flexible wiring tape carrying a driver IC.

FIG. 3 is a sectional view taken along the A-A line of FIG. 2.

FIG. 4 is an explanatory view showing a second embodiment of the invention, using another form of the chassis.

### DETAILED DESCRIPTION OF THE PREFERRED EMBODIMENTS

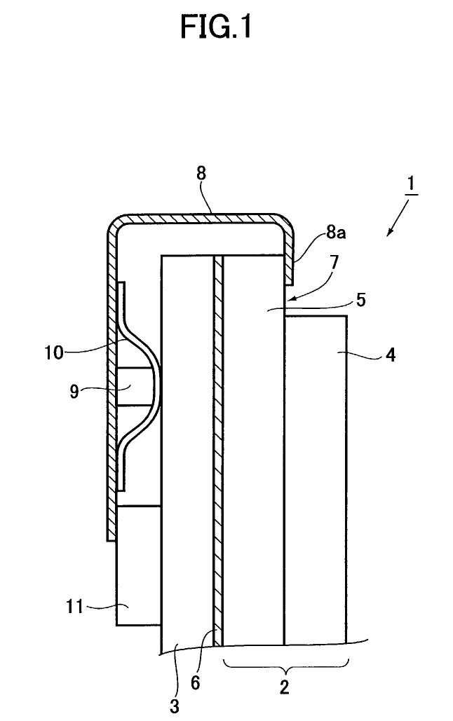

A first embodiment of a flat-panel type display apparatus according to the present invention will be described hereinafter in detail with reference to FIG. 1 to FIG. 3. The description of the embodiment of the flat-panel type display apparatus is made for a color plasma display panel having a driver-IC mounting structure according to the present invention.

FIG. 1 is a sectional view illustrating an essential part of the construction of the color plasma display panel which is predicated on the present invention. In FIG. 1, the color plasma display panel 1 includes a display body 2 and a metal chassis 3 supporting the display body 2. Mounted on the back surface of the metal chassis is a driver IC 9 (including silicon chips, semiconductor chips) and the like which are carried on a flexible wiring tape 8 for wiring. Reference numeral 11 represents a printed substrate.

The display body 2 has a front glass substrate 4 and a back glass substrate 5 which are arranged opposite to each other with a discharge space formed therebetween and filled with an inert gas. The front glass substrate 4 has an inner surface (surface facing the back glass substrate 5) on which a plurality of row electrode pairs are regularly arranged and covered with a dielectric layer. The back glass substrate 5 has an inner surface (surface facing the front glass substrate 4) on which a plurality of column electrodes are disposed so as to intersect (at right angles) the row electrode pairs and are overlaid with phosphor layers of different colors. Each of the intersections of each row electrode pair and each column electrode is designed to form a discharge cell. The driver IC 9 applies driving power for display to the row electrode pairs and the column electrodes on the basis of display data, to allow the color discharge cells to cause discharge and emit light for display of a color image.

The flat plate-shaped display body 2 is secured combinedly on a flat plate-shaped metal chassis 3 made of aluminum or the like by a bonding member 6 such as an adhesive double-faced tape or the like.

On a side edge 7 of the front side of the back glass substrate 5 are arranged a plurality of lead terminals connected to the column electrodes (hereinafter referred to as “column-electrode terminals”). On a side edge (not shown) of the rear side of the front glass substrate 4, are arranged a plurality of lead terminals connected to the row electrode pairs (hereinafter referred to as “row-electrode terminals”).

The flexible wiring tape 8 has an end portion 8a fastened to the side edge 7 of the back glass substrate 5. A predetermined joint end of a wiring pattern formed on the end 8a of the flexible wiring tape 8 is electrically connected to the column-electrode terminals and the row-electrode terminals through an anisotropically electrically-conductive bonding sheet or the like, so that the driver IC 9 and the display body 2 are electrically connected.

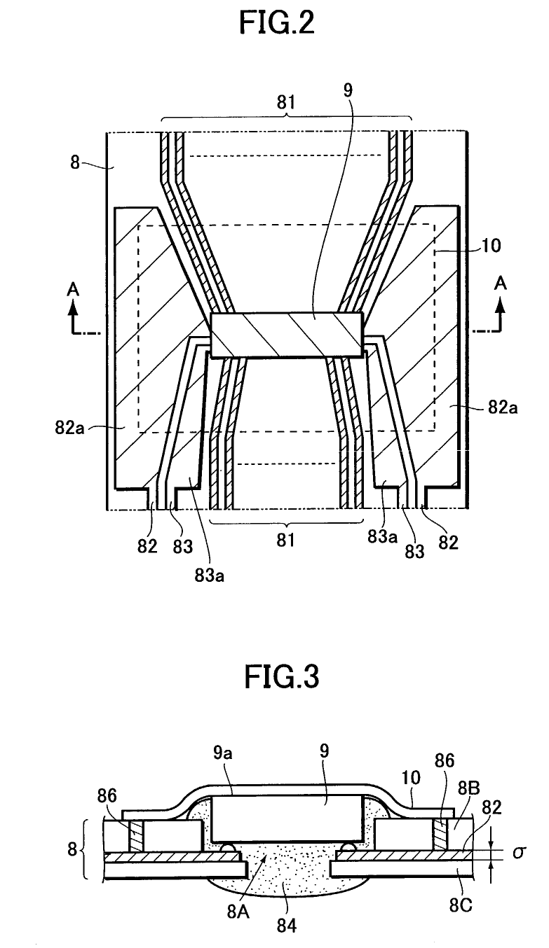

FIG. 2 is a plan view illustrating a wiring structure of the flexible wiring tape 8 carrying the driver IC 9. FIG. 3 is a sectional view taken along the A-A line in FIG. 2. The flexible wiring tape 8 has a signal wiring pattern 81 for transmitting signals, an earth wiring pattern 82 and a power-source wiring pattern 83 formed thereon, which are electrically connected to the driver IC 9, thereby to form TCP carrying the driver IC 9 on the flexible wiring tape 8 in advance.

When the driver IC 9 is to be mounted on the flexible wiring tape 8, the flexible wiring tape 8 is automatically conveyed by an automatically attaching machine, thereby positioning the driver IC 9 onto the flexible wiring tape 8. At this time, the driver IC 9 is placed in a manner such that a bonding pad and an electrical circuit face formed on the driver IC 9 come in contact with the aforementioned wiring patterns of the flexible wiring tape 8, and a back surface 9a of the driver IC 9 is oriented upward with respect to the flexible wiring tape 8.

At this time, as illustrated in the sectional view in FIG. 3, the flexible wiring tape 8 has an opening 8A in which a sealing resin (epoxy resin or the like) 84 is fed into an area where the driver IC 9 is carried. A metal plating film made of chromium and gold is formed on the back surface 9a of the driver IC 9 carried on the flexible wiring tape 8. In order to form the metal plating film, aback face of the chip undergoes the chromium and gold plating process after being polished by a grinder to remove an oxide film from the back face. After that, the back face 9a of the driver IC 9 is covered with an electrically conductive tape 10, which is then bonded on to the surface of the metal chassis 3 as illustrated in FIG. 1.

In the earth wiring pattern 82 and the power-source wiring pattern 83 on the flexible wiring tape 8 according to the present embodiment, widened portions 82a and 83a wider than the signal wiring pattern 81 are formed around the driver IC 9. Either one or both of the widened portions 82a and 83a are connected to the electrically conductive tape 10 by providing a joint portion 86 in abase film 8B. Further, the wiring pattern including the widened portions 82a, 83a is formed of a copper foil layer having a thickness of 30 μm or more (e.g. 35 μm). FIG. 3 also shows a cover layer 8C for covering the wiring patterns.

The color plasma display panel of the construction as described above makes it possible to dissipate the heat generated by the driver IC 9 by means of the widened portions 82a or 83a of the wiring pattern formed around the driver IC 9. In addition, since the wiring pattern including the widened portions 82a, 83a is formed of the copper foil of a thickness of 30 μm or more, the structure according to the present invention provides an adequate dissipating effect as compared with a conventional structure having a flexible wiring tape having a typical wiring pattern (about 18 μm). Moreover, by connecting the widened portions 82a or 83a of the wiring pattern to the conductive tape 10, the heat can be further effectively dissipated through the conductive tape 10.

The manner of mounting the device IC module (described above) on the display body 2 and the metal chassis 3 (as illustrated in FIG. 1) allows the heat (generated when the driver IC 9 drives the display body 2) to be efficiently transferred to the conductive tape 10. Hence, the electrically conductive tape having a large surface area and thermal conductivity has a satisfactory function of dissipating heat. Further, since the module is bonded to the metal chassis 3 through the conductive tape 10, a heat-dissipating function of the metal chassis 3 is added to provide an extremely satisfactorily dissipating effect.

Due to the connection of the back face 9a of the driver IC 9 (after the electrically conductive process) to the earth wiring pattern 82 through the conductive tape 10, an earth potential of the driver IC 9 is maintained at the same potential as that of the earth wiring pattern 82 of the flexible wiring tape 8 through the conductive tape 10, leading to an improvement in withstand voltage properties. In addition, the driver IC is stably mounted because the driver IC is fastened to the metal chassis by the conductive tape 10.

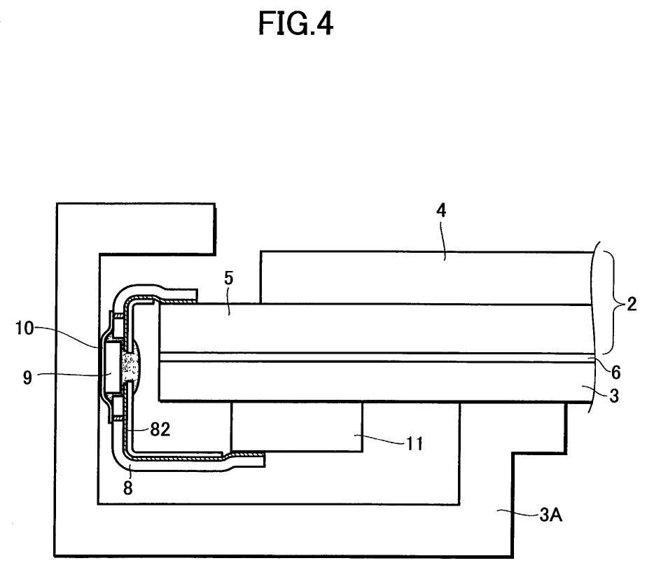

FIG. 4 is an explanatory view of a second embodiment using another form of the chassis. The same components as those in the first embodiment are indicated by the same reference numerals and part of the description is omitted. In a structure for mounting the device IC module on the display body 2 and the metal chassis 3 according to the second embodiment, an auxiliary chassis 3A is fastened to the metal chassis 3 so as to cover the side faces of the display body 2 and the metal chassis 3. The other face of the electrically conductive tape 10 (the face opposite to the face bonded to the driver IC 9) is bonded to one face of the auxiliary chassis 3A. The second embodiment provides a similar satisfactory dissipating effect as in the case of the first embodiment.

The present invention is not limited to the above-discussed embodiments. A first feature of the present invention is that either one or both of the earth wiring pattern 82 and the power-source wiring pattern 83 of the flexible wiring tape 8 are provided with the widened part 82a or 83a around the driver IC 9, and the thickness of the wiring pattern is larger than that of a usual wiring pattern in the prior art. This feature allows dissipation of the heat generated by the driver IC 9 regardless of the structure of mounting the TCP on the display body 2. Moreover, it is possible to provide a higher heat-dissipating effect when the conductive tape 10 is connected to the widened portions 82a or 83a, and further bonded to the metal chassis 3.

The present invention has the configuration as described above and therefore allows the provision of an improved flat-panel type display apparatus having a structure of mounting a driver IC which provides a significantly great effect of dissipating heat.

The terms and description used herein are set forth by way of illustration only and are not meant as limitations. Those skilled in the art will recognize that numerous variations are possible within the spirit and scope of the invention as defined in the following claims.

What is claimed is:

1. A flat-panel type display apparatus including a flat display panel and a metal chassis bonded on a back surface of the flat display panel, comprising,
a flexible wiring tape having predetermined signal wiring, earth wiring and power-source wiring, carrying a driver IC and connected to electrode terminals formed on a substrate of the flat display panel,
wherein at least one of the earth wiring and the power-source wiring has a widened portion formed around the driver IC.

2. A flat-panel type display apparatus according to claim 1, wherein each of said wirings on said flexible wiring tap has a thickness of 30 μm or more.

3. A flat-panel type display apparatus according to claim 1, wherein a back surface of said driver IC is covered with an electrically conductive tape, and the electrically conductive tape is connected to said widened portion and also bonded to said metal chassis.

4. A flat-panel type display apparatus according to claim 1, wherein said flat display panel is a color plasma display panel.
